(19) United States
(12) Patent Application Publication
(10) Pub. No.: US 2011/0003199 A1
(43) Pub. Date: Jan. 6, 2011

(54) NEGATIVE ELECTRODE ELEMENT FOR LITHIUM-ION SECONDARY BATTERY, LITHIUM-ION SECONDARY BATTERY AND METHOD OF MANUFACTURING THE SAME

(75) Inventors: Hideyuki Yamamura, Susono-shi (JP); Mitsuhiro Watanabe, Yokosuka-shi (JP); Takuya Ishida, Yokohama-shi (JP); Hideo Honma, Yokohama-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, Toyota-shi, Aichi-ken (JP); KANTO GAKUIN UNIVERSITY SURFACE ENGINEERING RESEARCH INSTITUTE, YOKOSUKA-SHI (JP)

(21) Appl. No.: 12/919,787

(22) PCT Filed: Apr. 6, 2009
(86) PCT No.: PCT/IB2009/005192

§ 371 Date: Aug. 27, 2010

(30) Foreign Application Priority Data
Apr. 7, 2008 (JP) 2008-099311

(51) Int. Cl. H01M 10/052; H01M 4/02; H01M 10/04; H01M 4/04

(52) U.S. Cl. 429/188; 429/209; 427/77

(57) ABSTRACT

A negative electrode element for a lithium-ion secondary battery includes: a negative electrode current collector; and a negative electrode layer that includes an alloying active material layer formed on the negative electrode current collector and a resin layer formed on a surface of the alloying active material layer so as to have an opening that exposes part of the alloying active material layer to a surface of the negative electrode layer. The surface of the alloying active material layer, exposed to the opening, and a surface of the resin layer form a step so that the surface of the resin layer is farther from a surface of the negative electrode current collector than the exposed surface of the alloying active material layer.

### BACKGROUND OF THE INVENTION

1. Field of the Invention

The invention relates to a negative electrode element for a lithium-ion secondary battery, which is excellent in cycle characteristics, a lithium-ion secondary battery, and a method of manufacturing a lithium-ion secondary battery.

2. Description of the Related Art

In the field of information-related devices and communication devices, with the reduction in size of a personal computer, a video camera, a cellular phone, or the like, lithium-ion secondary batteries are practically used and widely available as batteries used in those devices in terms of high energy density. Meanwhile, in the field of automobiles as well, development of an electric vehicle is an urgent task with environmental issues and resources issues as a background, and a lithium-ion secondary battery is considered as a power source for the electric vehicle.

Generally, a carbon material, such as graphite, is widely used as a negative electrode active material used for the lithium-ion secondary battery. However, the carbon material generally has small lithium-ion storage capacity, so tin, tin alloy, or the like, having a lithium-ion storage capacity larger than the carbon material is used as the negative, electrode active material, which is, for example, described in Japanese Patent Application Publication No. 2004-139768 (JP-A-2004-139768).

However, when such a lithium-ion secondary battery is charged and discharged, for example, in a negative electrode element 1 formed of a negative electrode current collector 2 and a negative electrode layer 5 as shown in FIG. 5A, an alloying active material that will be alloyed with lithium in the negative electrode layer 5 expands and contracts when lithium is absorbed and desorbed. Thus, cracks are formed in the negative electrode layer 5 as shown in FIG. 5B. In this state, when charging and discharging is further repeated, the negative electrode layer 5 cannot withstand steep expansion and contraction of the alloying active material to allow propagation of cracks in the negative electrode layer 5 as shown in FIG. 5C. Thus, the negative electrode layer 5 peels off or slips off. This impairs conductivity to disable charging and discharging and, as a result, the cycle characteristics decrease. Therefore, it is necessary to remove the above problem to thereby improve the cycle characteristics of a lithium-ion secondary battery.

In regard to the above problem, Japanese Patent Application Publication No. 2003-142088 (JP-A-2003-142088) describes a lithium-ion secondary battery in which a negative electrode current collector is plated with a tin or tin alloy plating film having substantially successive plating particles with an average particle diameter of less than 0.5 μm, and an electrode material having a thin negative electrode layer is used for the secondary battery. The thickness of the negative electrode layer is reduced to decrease a stress due to a volume change of the negative electrode layer during charging and discharging, thus attempting to improve the cycle characteristics. In the above case, because plating particles forming the negative electrode layer are small and dense, the stress due to a variation in volume may be reduced; however, the cycle characteristics are not improved enough for practical use.

In addition, as a method for further reducing a stress due to a volume change of a negative electrode layer, Japanese Patent Application Publication No. 2002-083594 (JP-A-2002-083594) describes an electrode for a lithium battery, in which a thin-film negative electrode layer made of a silicon-based negative electrode active material is separated by slits extending in the thickness direction. By providing slits in the negative electrode layer, even when the negative electrode layer expands or contracts during charging and discharging, gaps formed in the negative electrode layer reduce a stress, thus making it possible to suppress occurrence of a stress that causes the negative electrode layer to slip off. However, there is a limitation of handling a stress due to expansion and contraction of the negative electrode layer only with the above described structure of the negative electrode layer, and it has been difficult to suppress a slip of the negative electrode layer.

Then, a negative electrode element for a lithium-ion secondary battery as shown in FIG. 6A is suggested. In the negative electrode element, an alloying active material layer 3 made of a negative electrode active material having a rough surface is formed on a negative electrode current collector 2, the surface of the alloying active material layer 3 is coated with resin, and then part of the surface is removed by etching. Thus, the alloying active material layer 3 and the resin layer 4 are flush with each other. By coating the alloying active material layer with the resin layer 4, a volume change of the alloying active material layer during charging and discharging is suppressed while the alloying active material layer is held. Thus, it is possible to suppress a slip of the alloying active material layer. In addition, it is also advantageous in that reactivity between an electrolytic solution and the alloying active material layer is reduced to thereby make it possible to prevent degradation of the electrolytic solution. However, in this case as well, for example, lithium is inserted into portions of the alloying active material layer 3 exposed on the surface, as shown in FIG. 6B. Thus, the exposed portions expand to form protrusions 20. Therefore, when this negative electrode element 1 is used for a lithium-ion secondary battery, it may damage an adjacent separator. In addition, lithium is desorbed also from the side faces of the protrusions 20 expanded at the exposed portions as shown in FIG. 6C. Thus, it is presumable that the narrow protrusions 20 may be left or the proximal portions of the protrusions 20 may break and then part of the negative electrode layer may peel off.

Japanese Patent Application Publication No. 2005-197258 (JP-A-2005-197258), Japanese Patent Application Publication No. 2006-139967 (JP-A-2006-139967), Japanese Patent Application Publication No. 2006-517719 (JP-A-2006-517719) describe that a negative electrode layer is protected by a material other than resin; however, any one of these techniques does not suppress a slip of the negative electrode layer.

### SUMMARY OF THE INVENTION

The invention provides a negative electrode element for a lithium-ion secondary battery, which is excellent in cycle characteristics, a lithium-ion secondary battery that uses the negative electrode element, and a method of manufacturing a lithium-ion secondary battery.

A first aspect of the invention provides a negative electrode element for a lithium-ion secondary battery. The negative electrode element includes: a negative electrode current collector; and a negative electrode layer that includes an alloying active material layer and a resin layer, wherein the alloying active material layer is formed on the negative electrode current collector, wherein the resin layer is formed on a surface of the alloying active material layer so as to have an opening that exposes part of the alloying active material layer to a surface of the negative electrode layer, wherein the surface of the alloying active material layer, exposed to the opening, and a surface of the resin layer form a step so that the surface of the resin layer is farther from a surface of the negative electrode current collector than the exposed surface of the alloying active material layer.

According to the first aspect, the entire surface of the alloying active material layer is covered with the resin layer having the opening. Thus, it is possible to suppress expansion and contraction of the alloying active material layer. Hence, it is possible to reduce local concentration of a stress, generated by a volume change, on the alloying active material layer. This can prevent occurrence of a crack, a slip, or the like, of the alloying active material layer. In addition, because the entire surface of the alloying active material layer is covered with the resin layer having the opening, even when a fracture or a crack is formed in the alloying active material layer, it is possible to prevent a peeling or slip of the alloying active material layer from the negative electrode current collector. Furthermore, the surface of the alloying active material layer, exposed to the opening, and the surface of the resin layer form a step so that the surface of the resin layer is farther from the surface of the negative electrode current collector than the exposed surface of the alloying active material layer. Thus, when lithium is inserted into the alloying active material layer, the expanded portion of the alloying active material layer is formed inside the opening of the resin layer, whereas, when lithium is desorbed, because the expanded portion of the alloying active material layer is formed inside the opening, lithium is not desorbed from the side surface of the alloying active material layer covered with the resin layer, and lithium is selectively desorbed only from a portion that is in contact with an electrolytic solution. Thus, it is possible to form the shape of the alloying active material layer, which hardly causes a slip. In addition, with the above resin layer, it is possible to reduce reactivity between the alloying active material layer and an electrolytic solution. Thus, degradation of an electrolytic solution may be prevented.

In the negative electrode element for a lithium-ion secondary battery according to the first aspect, a plurality of the openings may be formed over the entire surface of the resin layer.

In the negative electrode element for a lithium-ion secondary battery according to the first aspect, the resin layer may cover an end portion of the alloying active material layer. By covering the end portion of the alloying active material layer with the resin layer, it is possible to suppress a peeling or a slip not only in the laminated direction at the time when lithium is inserted or desorbed but also at the end portion of the alloying active material layer.

In the negative electrode element for a lithium-ion secondary battery according to the first aspect, the size of the step may fall within the range of 0.01 μm to 10 μm. When the size of the step falls within the above range, the expanded portion of the alloying active material layer is formed inside the opening of the resin layer when lithium is inserted into the alloying active material layer. Thus, it is possible to reduce an adverse effect to an adjacent member when used in a battery. In addition, when lithium is desorbed, because the expanded portion of the alloying active material layer is surrounded by the resin layer, lithium is not desorbed from the side surface of the expanded portion, and lithium is desorbed only from a portion that is in contact with an electrolytic solution. Thus, it is possible to prevent the shape of the alloying active material layer from being changed into the one that easily causes a slip.

In the negative electrode element for a lithium-ion secondary battery according to the first aspect, the size of the step may fall within the range of 1 pin to 3 μm.

In the negative electrode element for a lithium-ion secondary battery according to the first aspect, the entire surface of the alloying active material layer may be covered with the resin layer.

In the negative electrode element for a lithium-ion secondary battery according to the first aspect, the percentage of an area of the opening to an area of the entire resin layer may fall within the range of 10% to 50%.

In the negative electrode element for a lithium-ion secondary battery according to the first aspect, the percentage of an area of the opening to an area of the entire resin layer may fall within the range of 30% to 40%.

A second aspect of the invention provides a lithium-ion secondary battery. The lithium-ion secondary battery includes: the above described negative electrode element for a lithium-ion secondary battery; a positive electrode element for a lithium-ion secondary battery, which includes a positive electrode current collector and a positive electrode layer; a separator that is arranged between the negative electrode layer and the positive electrode layer; and a nonaqueous electrolytic solution that contains lithium salt.

According to the second aspect, because the lithium-ion secondary battery includes the above described negative electrode element for a lithium-ion secondary battery, degradation of the negative electrode layer, such as a peeling or a slip of the alloying active material layer, hardly occurs during charging and discharging. Thus, degradation of the cycle characteristics is suppressed, and, therefore, it is possible to obtain a long-life high-capacity lithium-ion secondary battery.

A third aspect of the invention provides a method of manufacturing a lithium-ion secondary battery. The method includes: forming an alloying active material layer on a negative electrode current collector; and forming a resin layer on a surface of the alloying active material layer so as to have an opening that exposes part of the alloying active material layer to a surface of a negative electrode layer.

In the method of manufacturing a lithium-ion secondary battery according to the third aspect, the alloying active material layer may be formed after a surface of the negative electrode current collector is roughened.

According to the aspects of the invention, it is possible to obtain a negative electrode element for a lithium-ion secondary battery, which is excellent in cycle characteristics, a lithium-ion secondary battery that uses the negative electrode element, and a method of manufacturing a lithium-ion secondary battery.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1A to FIG. 1C are schematic cross-sectional views that show an example of a negative electrode element for a lithium-ion secondary battery according to an embodiment of the invention;

FIG. 2A and FIG. 2B are schematic cross-sectional views that show another example of a negative electrode element for a lithium-ion secondary battery according to the embodiment of the invention;

FIG. 3 is a schematic cross-sectional view that shows an example of a lithium-ion secondary battery according to the embodiment of the invention;

FIG. 4A to FIG. 4D are process drawings that show an example of a method of manufacturing a lithium-ion secondary battery according to the embodiment of the invention;

FIG. 5A to FIG. 5C are views that illustrate cracks formed in a negative electrode layer according to a related art; and

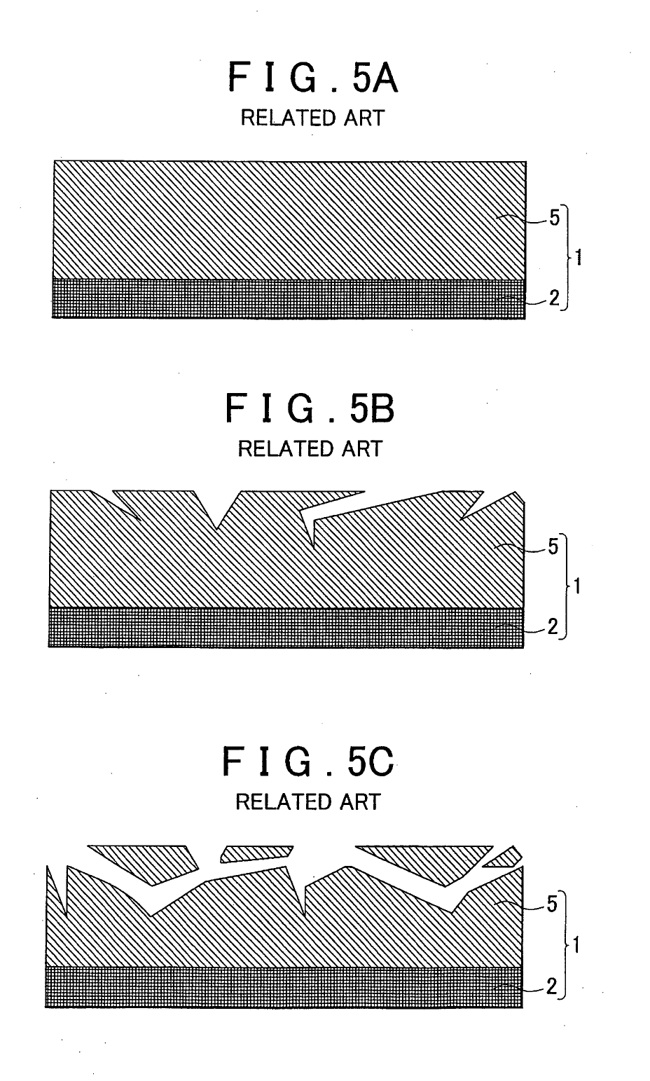

FIG. 6A to FIG. 6C are views that illustrate cracks formed in a negative electrode layer according to a related art.

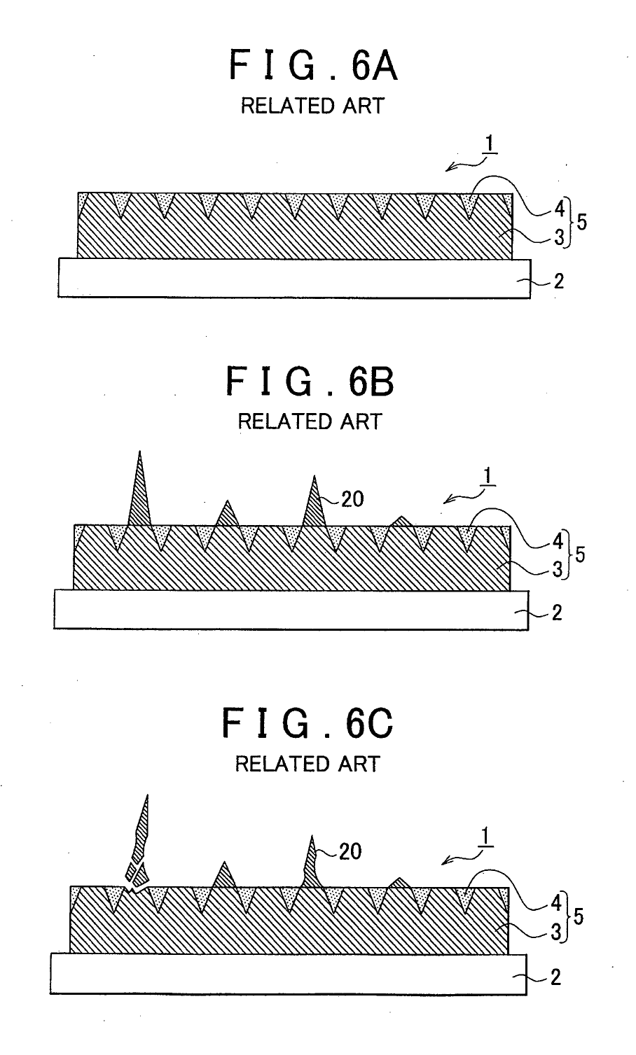

### DETAILED DESCRIPTION OF EMBODIMENTS

An embodiment of the invention provides a negative electrode element for a lithium-ion secondary battery, a lithium-ion secondary battery that uses the negative electrode element, and a method of manufacturing a lithium-ion secondary battery. Hereinafter, these will be described in detail.

According to the embodiment of the invention, a negative electrode element for a lithium-ion secondary battery includes: a negative electrode current collector; and a negative electrode layer that includes an alloying active material layer and a resin layer, wherein the alloying active material layer is formed on the negative electrode current collector, wherein the resin layer is formed on a surface of the alloying active material layer so as to have an opening that exposes part of the alloying active material layer to a surface of the negative electrode layer, wherein the surface of the alloying active material layer, exposed to the opening, and a surface of the resin layer form a step so that the surface of the resin layer is farther from a surface of the negative electrode current collector than the exposed surface of the alloying active material layer.

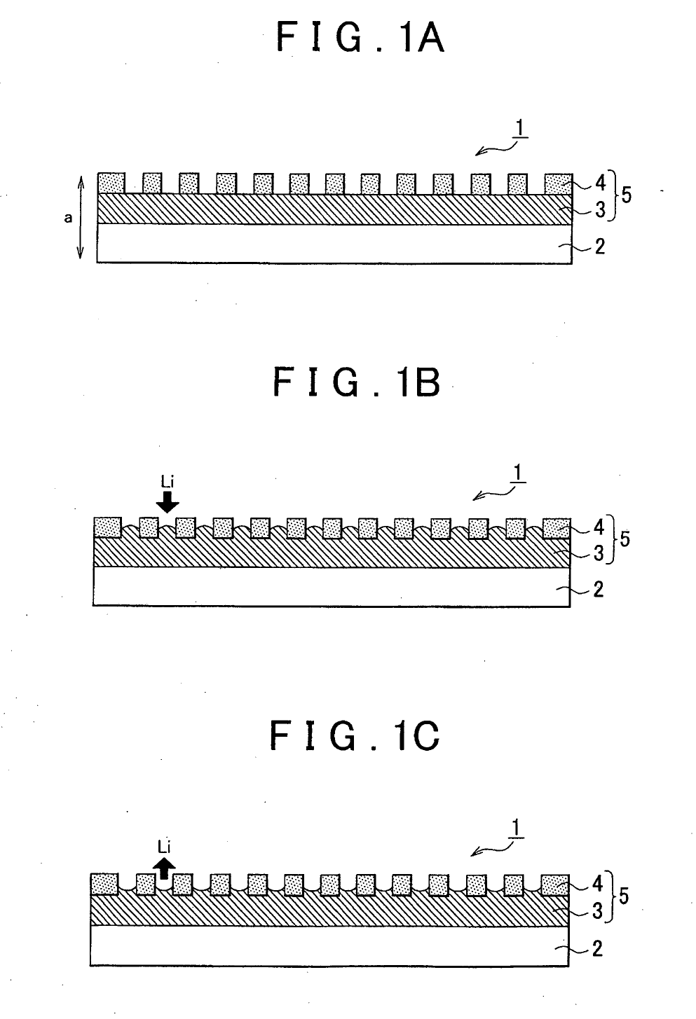

The negative electrode element for a lithium-ion secondary battery according to the embodiment of the invention will be described with reference to the accompanying drawings. FIG. 1A to FIG. 1C are schematic cross-sectional views that show an example of the negative electrode element for a lithium-ion secondary battery according to the embodiment of the invention. As shown in FIG. 1A, the negative electrode element 1 for a lithium-ion secondary battery according to the embodiment of the invention includes a negative electrode current collector 2 and a negative electrode layer 5 that includes an alloying active material layer 3 and a resin layer 4, which are formed on the negative electrode current collector 2. Here, the resin layer 4 has a plurality of openings formed on a surface of the alloying active material layer 3 uniformly over the entire surface of the resin layer 4 so that part of the alloying active material layer 3 is exposed to a surface of the negative electrode layer 5. The surface of the alloying active material layer 3, exposed to the openings, and the surface of the resin layer 4 form steps so that the surface of the resin layer 4 is farther from a surface of the negative electrode current collector 2 than the surface of the alloying active material layer 3.

According to the present embodiment, the entire surface of the alloying active material layer is covered with the resin layer having the openings. Thus, it is possible to suppress expansion and contraction of the alloying active material layer. Hence, it is possible to reduce local concentration of a stress, generated by a volume change of the alloying active material layer, on the alloying active material layer. This can prevent occurrence of a slip, or the like, of the alloying active material layer. In addition, because the surface of the alloying active material layer is covered with the resin layer, even when a fracture or a crack is formed in the alloying active material layer, it is possible to suppress a slip of the alloying active material layer, a peeling of the alloying active material layer from the negative electrode current collector, or the like. According to the present embodiment, the resin layer has openings. Thus, for example, as shown in FIG. 1B, if the alloying active material layer 3 expands at the time when lithium is inserted, the expanded portions are formed inside the openings. Therefore, the resin layer 4 is formed to have a certain amount of thickness to thereby form a step between the surface of the alloying active material layer 3 and the surface of the resin layer 4. By so doing, when the negative electrode element 1 is used for the battery, it is possible to eliminate the problem that, for example, a member, such as an adjacent separator, is damaged. In addition, as shown in FIG. 1C, when lithium is desorbed, because the expanded portions of the alloying active material layer 3 are formed inside the openings, lithium is not desorbed from side surfaces of the expanded portions covered with the resin layer 4, and lithium is selectively desorbed only from portions that are in contact with an electrolytic solution. Thus, it is possible to suppress a peeling or a slip of the alloying active material layer due to remaining of the expanded portions. Furthermore, with the resin layer, it is possible to reduce reactivity between the alloying active material layer and the electrolytic solution. Thus, it is advantageous in that degradation of the electrolytic solution may be prevented.

The size of each step desirably falls within the range of 0.01 μm to 10 μm, and particularly falls within the range of 1 μm to 3 μm. This is because, if the size of each step exceeds the above range, the efficiency of power generation per unit volume decreases, whereas, if the size of each step does not reach the above range, the expanded portions of the alloying active material layer may be higher than the surface of the resin layer at the time when lithium is inserted to thereby cause an adverse effect, such as a damage to an adjacent member.

Hereinafter, components of the negative electrode element for a lithium-ion secondary battery according to the embodiment of the invention will be described.

The negative electrode layer used in the present embodiment includes: an alloying active material layer that is formed on a negative electrode current collector, which will be described later; and a resin layer that is formed on a surface of the alloying active material layer so as to have openings that expose part of the alloying active material layer to a surface of the negative electrode layer, wherein the surface of the alloying active material layer, exposed to the openings, and a surface of the resin layer form steps so that the surface of the resin layer is farther from a surface of the negative electrode current collector than the exposed surface of the alloying active material layer. Hereinafter, the resin layer and the alloying active material layer will be respectively described.

First, the resin layer used for the negative electrode layer will be described. The resin layer used in the present embodiment is formed to suppress a slip of the alloying active material layer, and has openings. Because the resin layer has the openings, the resin layer is able to control a change of the shape of the alloying active material layer at the time when lithium is inserted or desorbed to thereby prevent occurrence of a crack, a peeling, a slip, or the like.

The shape of each opening of the resin layer is not specifically limited as long as the shape is able to hold the strength of the resin layer, and may be, for example, circular, rectangular, triangular, rhombic, or the like.

In addition, the pattern shape of the openings of the resin layer is not specifically limited as long as the pattern shape is such that expansion and contraction of the entire alloying active material layer may be suppressed when the entire alloying active material layer is covered with the resin layer, and the shape of the alloying active material layer suppresses occurrence of a slip even when expansion and contraction of the alloying active material layer occurs inside the openings of the resin layer. The pattern shape of the openings may be, for example, a known pattern shape, such as a stripe pattern, a staggered pattern, and a lattice pattern.

The percentage of the area of the openings to the area of the entire resin layer used in the present embodiment desirably falls within the range of 10% to 50%, and more desirably falls within the range of 30% to 40%. This is because, if the percentage of the area does not reach the above range, reactivity between the electrolytic solution and the alloying active material layer reduces to an extent such that a sufficient capacity cannot be obtained, whereas, if the percentage of the area exceeds the above range, there is a possibility that expansion and contraction of the entire alloying active material layer cannot be suppressed.

In addition, the thickness of the resin layer is not specifically limited as long as expansion and contraction of the entire alloying active material layer in the laminated direction (direction indicated by a in FIG. 1) may be prevented, and steps may be formed between the surface of the resin layer and the surface of the alloying active material layer so that the expanded portions of the alloying active material layer do not protrude from the surface of the resin layer at the time when lithium is inserted. The above thickness of the resin layer desirably falls within the range of 0.01 μm to 10 μm, and more desirably falls within the range of 1 μm to 3 μm. This is because, if the thickness does not reach the above range, expansion and contraction of the alloying active material layer cannot be sufficiently suppressed and, therefore, a peeling or a slip may occur in the alloying active material layer. In addition, this is because the expanded portions of the alloying active material layer formed at the openings may damage an adjacent member. This is also because, if the thickness exceeds the above range, the efficiency of power generation per unit volume decreases.

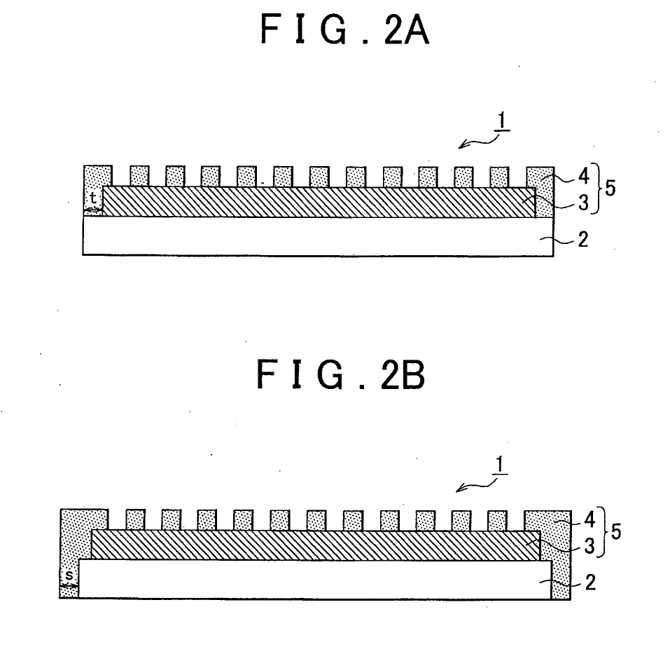

The resin layer used in the present embodiment is not specifically limited as long as the one that covers the surface of the alloying active material layer; however, as illustrated in FIG. 2A, the resin layer 4 desirably covers end portions of the alloying active material layer 3. This is because, by so doing, it is possible to handle expansion and contraction at the end portions of the alloying active material layer. In the above case, the thickness of the resin layer at the end portions of the alloying active material layer is not specifically limited as long as the thickness is such an extent that expansion and contraction of the alloying active material layer are suppressed so as to be able to prevent occurrence of a peeling or a slip at the end portions of the alloying active material layer, and the efficiency of power generation per unit volume does not decrease. Here, the phrase “thickness of the resin layer at the end portions of the alloying active material layer” indicates a thickness t in FIG. 2A. In addition, in the present embodiment, as illustrated in FIG. 2B, the resin layer 4 more desirably covers end portions of the negative electrode current collector 2. This is because it is possible to prevent a damage to the negative electrode current collector when the negative electrode current collector is expanded with a volume change of the alloying active material layer. In this way, when the resin layer covers the end portions of the negative electrode current collector, the thickness of the resin layer at the end portions of the negative electrode current collector is not specifically limited as long as the thickness is such an extent that it is possible to prevent a damage to the negative electrode current collector when the negative electrode current collector is expanded with a volume change of the alloying active material layer, and the efficiency of power generation per unit volume does not decrease. Here, the phrase “thickness of the resin layer at the end portions of the negative electrode current collector” indicates a thickness s in FIG. 2B. In addition, the undescribed reference numerals in FIG. 2A and FIG. 2B are the same as those of FIG. 1A to FIG. 1C, so the description thereof is omitted.

The resin layer is formed to suppress expansion and contraction of the entire alloying active material layer and to suppress occurrence of a slip of the alloying active material layer. The material used for the resin layer is not specifically limited as long as the material suppresses expansion and contraction of the entire alloying active material layer, and is able to suppress occurrence of a crack in the alloying active material layer. In the present embodiment, it is desirable to use elastic resin so that the resin layer is able to deform in accordance with a volume change of the alloying active material layer in order to suppress expansion and contraction of the alloying active material layer and to reduce a stress generated by a volume change of the alloying active material layer. In addition, when the negative electrode element for a lithium-ion secondary battery according to the embodiment of the invention is used in a lithium-ion secondary battery, the resin layer contacts an electrolytic solution. Therefore, it is desirable that components in the resin layer do not dissolve into the electrolytic solution. Furthermore, because the resin layer is used for the lithium-ion secondary battery, the resin layer is desirably resistant to electrolysis.

The material of the resin layer is not specifically limited as long as the material has the above described property. The material may be, for example, a thermoplastic resin, a thermosetting resin, an ultraviolet curing resin, or the like. Specifically, the material may be polyurethane, epoxy resin, polyimide, acrylic resin, olefin resin, bismaleimide-triazine, LCP, cyanate resin (cyanate ester), polyphenylene oxide resin, polyethylene naphthalate, polyurea, or the like. Two or more types of these resins may be used as a composite resin.

The alloying active material layer used in the present embodiment is made of a chemical element that can be alloyed with lithium and is formed on the negative electrode current collector, which will be described later.

The chemical element is not specifically limited as long as it can be alloyed with lithium ion, and may be metal lithium, silicon, tin, aluminum, or an alloy of them. In the present embodiment, particularly, tin is desirable.

The thickness of the alloying active material layer is not specifically limited and may be adjusted as needed depending on application of the lithium-ion secondary battery. The thickness desirably falls within the range of 1 μm to 6 μm, specifically, falls within the range of 1 μm to 3 μm, and more specifically falls within the range of 1 μm to 2 μm. This is because, if the thickness does not reach the above range, there is a possibility that a sufficient capacity cannot be obtained, whereas, if the thickness exceeds the above range, a volume change is large at the time when lithium is inserted or desorbed and, therefore, a crack may easily occur.

In the alloying active material layer used in the present embodiment, in order to improve adhesion to the above described resin layer, the surface of the alloying active material layer may be roughened. The surface roughness is adjusted as needed by the material used for the alloying active material layer, the material used for the resin layer, and the like.

The negative electrode layer used in the present embodiment includes the above described resin layer and alloying active material layer. The thickness of the negative electrode layer used in the present embodiment is desirably 10 μm or below and, particularly, falls within the range of 1 μm to 8 μm. This is also because, if the thickness exceeds the above range, the efficiency of power generation per unit volume decrease. Here, the phrase “thickness of the negative electrode layer” indicates the thickness of a portion at which the alloying active material layer and the resin layer are laminated.

The size of the negative electrode layer used in the present embodiment is adjusted as needed depending on the type of lithium-ion secondary battery that uses the negative electrode layer.

A method of forming a negative electrode layer according to the embodiment of the invention will be described when the method of manufacturing a lithium-ion secondary battery is described, so the description is omitted here.

The negative electrode current collector used in the present embodiment has the function of collecting electric current from the negative electrode layer.

The material of the negative electrode current collector may be, for example, copper, SUS, nickel, or the like, and desirably, copper. In addition, the shape of the negative electrode current collector may be, for example, foil-like, plate-like, mesh-like, or the like, and desirably foil-like.

The negative electrode element for a lithium-ion secondary battery according to the embodiment of the invention includes the above described negative electrode layer and negative electrode current collector, and is used to form a lithium-ion secondary battery together with a positive electrode element for a lithium-ion secondary battery, a separator, an electrolytic solution, and a battery case.

In addition, application of the negative electrode element for such a lithium-ion secondary battery may be, for example, a lithium-ion secondary battery used for a vehicle, or the like.

Next, the lithium-ion secondary battery according to the embodiment of the invention will be described. The lithium-ion secondary battery according to the embodiment of the invention includes the above described negative electrode element for a lithium-ion secondary battery, a positive electrode element for a lithium-ion secondary battery, which includes a positive electrode current collector and a positive electrode layer, a separator formed between the negative electrode layer and the positive electrode layer, and a nonaqueous electrolytic solution that contains lithium salt.

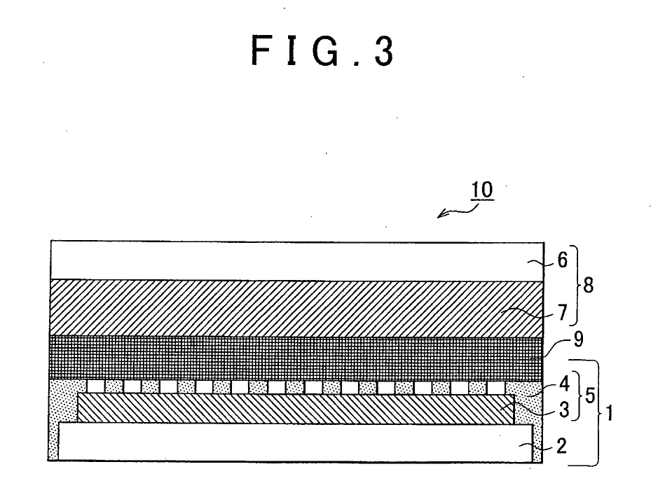

The lithium-ion secondary battery according to the embodiment of the invention will be described with reference to the drawings. FIG. 3 is a schematic cross-sectional view that shows an example of the lithium-ion secondary battery according to the embodiment of the invention. The lithium-ion secondary battery 10 shown in FIG. 3 includes a negative electrode element 1 for a lithium-ion secondary battery, a positive electrode element 8 for a lithium-ion secondary battery, a separator 9, and a nonaqueous electrolytic solution (not shown). The negative electrode element 1 includes a negative electrode current collector 2 and a negative electrode layer 5. The negative electrode layer 5 includes an alloying active material layer 3 and a resin layer 4 and is formed on the negative electrode current collector 2. The positive electrode element 8 includes a positive electrode current collector 6 and a positive electrode layer 7 that is formed on the positive electrode current collector 6 and that contains a positive electrode active material. The separator 9 is arranged between the negative electrode layer 5 and the positive electrode layer 7. The nonaqueous electrolytic solution conducts lithium ions between the positive electrode active material and the negative electrode active material.

According to the present embodiment, because the lithium-ion secondary battery includes the above described negative electrode element, degradation of the negative electrode layer, such as a peeling and a slip, due to a crack of the alloying active material layer hardly occurs. Thus, it is possible to obtain a lithium-ion secondary battery that has a high capacity and high cycle characteristics. Hereinafter, components of the lithium-ion secondary battery according to the embodiment of the invention will be described.

The negative electrode element for a lithium-ion secondary battery, used in the present embodiment, is described above, so the description is omitted here.

The positive electrode element for a lithium-ion secondary battery, used in the present embodiment, includes the positive electrode current collector and the positive electrode layer. Hereinafter, these components will be described.

The positive electrode layer used in the positive electrode element for a lithium-ion secondary battery contains a positive electrode active material that is able to absorb and desorb lithium.

The above positive electrode active material may be, for example, metal lithium, LiCoO₂, LiCoO₄, LiMn₂O₄, LiNiO₂, LiFePO₄, or the like.

In addition, the positive electrode layer may further contain a conductive agent and a binder. The binder may be, for example, polyvinylidene fluoride (PVDF), polytetrafluoroethylene (PTFE), or the like. The conductive agent may be, for example, a carbon black such as acetylene black and Ketjen black.

The positive electrode current collector collects electric current from the positive electrode layer. The material of the positive electrode current collector is not specifically limited as long as the material has conductivity, and may be, for example, aluminum, SUS, nickel, iron, titanium, or the like, and desirably aluminum or SUS. Furthermore, the positive electrode current collector may be a dense metal current collector or may be a porous metal current collector.

A method of forming the positive electrode element for a lithium-ion secondary battery is not specifically limited, and may be a method similar to a typical method of forming a positive electrode element. Specifically, the method may include preparing a positive electrode layer forming paste containing a positive electrode active material, a binder, and a solvent, applying the positive electrode layer forming paste onto a positive electrode current collector, and then drying the applied paste. Note that at this time, in order to improve the electrode density of the positive electrode layer, the positive electrode layer may be pressed.

Next, the separator used in the present embodiment will be described. The separator used in the present embodiment is provided between electrodes having different polarities as described above, and has the function of holding an electrolyte, which will be described later. The material of the separator is not specifically limited as long as the material is provided between the electrodes having different polarities and is able to have the function of holding an electrolyte, which will be described later. The material may be, for example, a resin, such as polyethylene (PE), polypropylene (PP), polyester, cellulose, and polyamide, and desirably, polypropylene. In addition, the separator may have a single-layer structure or may have a multilayer structure. The separator having a multilayer structure may be, for example, a separator having a double-layer structure of PE/PP, a separator having a triple-layer structure of PP/PE/PP, or the like. Furthermore, in the present embodiment, the separator may be a porous membrane or a nonwoven fabric, such as a resin nonwoven fabric and a glass fiber nonwoven fabric. Among others, the porous membrane is desirable.

In the present embodiment, a nonaqueous electrolytic solution that contains lithium salt is usually contained in the electrodes and current collectors of the above described electrode elements and in the separator. The nonaqueous electrolytic solution usually includes lithium salt and nonaqueous solvent. The lithium salt is not specifically limited as long as the lithium salt is generally used for a lithium-ion secondary battery, and may be, for example, LiPF₆, LiBF₄, LiN(CF₃SO₂)₂, LiCF₃SO₃, LiC₄F₉SO₃, LiC(CF₃SO₂)₃, LiClO₄, or the like. On the other hand, the nonaqueous solvent is not specifically limited as long as the nonaqueous solvent is able to dissolve the lithium salt, and may be, for example, propylene carbonate, ethylene carbonate, diethyl carbonate, dimethyl carbonate, ethylmethyl carbonate, 1,2-dimethoxyethane, 1,2-diethoxyethane, acetonitrile, propionitrile, tetrahydrofuran, 2-methyltetrahydrofuran, dioxane, 1,3-dioxolane, nitromethane, N,N-dimethylformamide, dimethyl sulfoxide, sulfolane, γ-butyrolactone, or the like. In the present embodiment, only one of these nonaqueous solvents may be used or a mixture of two or more of these nonaqueous solvents may be used. In addition, a room temperature molten salt may be used as the nonaqueous electrolytic solution.

When the lithium-ion secondary battery used in the present embodiment is, for example, formed of a laminated structure, the lithium-ion secondary battery illustrated in FIG. 3 is usually contained in a battery case, and the periphery of the lithium-ion secondary battery is sealed. The battery case is generally made of metal, and may be, for example, made of stainless steel. In addition, the shape of the battery case used in the present embodiment is not specifically limited as long as the battery case can accommodate the above described separator, positive electrode layer, negative electrode layer, and the like. Specifically, the battery case may be, for example, cylindrical, square, coin-shaped, or laminated.

In addition, application of the above lithium-ion secondary battery may be, for example, used in vehicles, or the like.

The method of manufacturing a lithium-ion secondary battery according to the embodiment of the invention is a method of manufacturing the above described lithium-ion secondary battery, and includes: an alloying active material layer forming process of forming an alloying active material layer on a negative electrode current collector; and a resin layer forming process of forming a resin layer on a surface of the alloying active material layer so as to have an opening that exposes part of the alloying active material layer to a surface of a negative electrode layer.

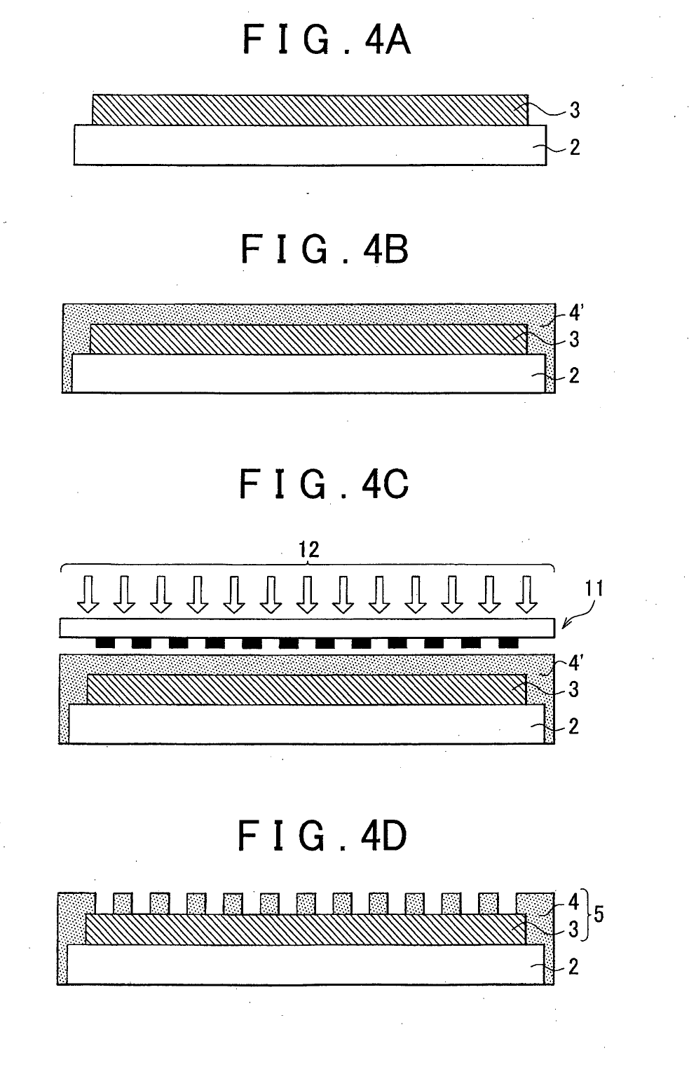

FIG. 4A to FIG. 4D are process drawings that show an example of the method of manufacturing a lithium-ion secondary battery according to the embodiment of the invention. The method of manufacturing a lithium-ion secondary battery according to the embodiment of the invention includes: an alloying active material layer forming process of forming an alloying active material layer 3 on a negative electrode current collector 2 as shown in FIG. 4A; and a resin layer forming process of forming a resin layer 4 on a surface of the alloying active material layer 3 so as to have openings that expose part of the alloying active material layer 3 to a surface of a negative electrode layer 5 as shown in FIG. 4B to FIG. 4D. The resin layer forming process, when, for example, using photolithography, includes: a resin film forming process (FIG. 4B) of forming a resin film 4′ so as to cover the negative electrode current collector 2 and the alloying active material layer 3 and drying the resin film 4′; an exposure process (FIG. 4C) of exposing the applied resin to light 12 using an exposure mask 11; a developing process of, after the exposure, developing the exposed resin to form the resin layer 4, and the like.

According to the present embodiment, when the negative electrode element for a lithium-ion secondary battery is manufactured as described above, the negative electrode element is less likely to form a crack during charging and discharging, and the lithium-ion secondary battery manufactured in accordance with the above manufacturing method may have a high capacity and high cycle characteristics. Hereinafter, the processes will be described.

The alloying active material layer forming process is a process of forming an alloying active material layer on a negative electrode current collector.

The method of forming the negative electrode layer on the negative electrode current collector is not specifically limited, and may be, for example, sputtering, PVD, CVD, electrolytic plating, electroless plating, or the like, and desirably sputtering or electrolytic plating.

In the alloying active material layer forming process, in order to roughen the surface of the alloying active material layer, a process of, for example, roughening the surface of the negative electrode current collector may be performed in advance. This may improve adhesion between the resin layer and the alloying active material layer.

The resin layer forming process is a process of forming a resin layer on a surface of the alloying active material layer so as to have an opening that exposes part of the alloying active material layer to a surface of a negative electrode layer.

The method of forming a resin layer, used in the resin layer forming process, may be a method including two processes, that is, a process of forming a resin layer on the entire surface of the alloying active material layer and then a process of removing part of the resin layer to form an opening, or a method including one process, that is, a process of forming a resin layer having an opening on the entire surface of the alloying active material layer.

In the resin layer forming process, when the resin layer is formed by two processes, the method of forming the resin layer on a surface of the alloying active material layer is not specifically limited as long as a resin layer having a uniform thickness may be formed. The method may be, for example, film lamination, roll coating, spraying, curtain coating, electrodeposition, screen printing, thermocompression bonding, bar coating, or the like.

In addition, the method of removing part of the resin layer formed as described above may be, for example, photolithography as shown in FIG. 4B to FIG. 4D, a method of removing part of the resin layer by laser irradiation, or the like.

In the resin layer forming process, when the resin layer is formed by one process, the method of forming the resin layer on a surface of the alloying active material layer may be, for example, film lamination in which a film on which the pattern shape of the resin layer is formed is stuck on a surface of the alloying active material layer, printing such as screen printing, electrodeposition in which a mask is arranged on the alloying active material layer and then the resin layer is formed from above the mask, vacuum vapor deposition, or the like.

The method of manufacturing a lithium-ion secondary battery according to the embodiment of the invention usually includes, in addition to the above described alloying active material layer forming process and resin layer forming process; a positive electrode element forming process of forming a positive electrode element for a lithium-ion secondary battery, an assembling process of assembling the components, and the like. These processes are similar to the processes that are typically used in manufacturing a lithium-ion secondary battery, so the description thereof is omitted here.

Note that the aspects of the invention are not limited to the above embodiment. The above embodiment is illustrative; the technical scope of the invention also encompasses any embodiments that have substantially similar configuration to that of the technical idea recited in the appended claims and that have similar operations and advantages.

Hereinafter, the embodiment of the invention will be further specifically described by illustrating an example. Formation of an alloying active material layer in the example will be described. First, an acidic cleaner DP-320 (produced by Okuno Chemical Industries Co., Ltd.) was put in a 100 ml beaker, and was adjusted to 30° C. A 18-micron copper foil was subjected to the cleaner for 60 seconds to clean the surface of the copper foil. After that, the copper foil was washed using distilled water for 30 seconds to rinse the cleaner. The washed copper foil was immersed in sulfuric acid for 60 seconds at room temperature, impurities on the surface was washed off with acid, and then the surface was rinsed again. The thus treated copper foil was immersed in an electrotinning bath (the tinning bath includes stannous sulfate 30 g/L, sulfuric acid 100 ml/L, additive agent 30 ml/L), and was subjected to electrodeposition at 3.5 A/dm² for 40 seconds. Thus, the alloying active material layer having a thickness of 0.5 μm was obtained.

Measurement of a film in the example will be described. The film state of the obtained alloying active material layer was measured by measuring the amount of deposition through deposition weight measurement. In addition, the surface shape was observed by scanning electron microscope (SEM), the surface area was measured by ultradeep shape measurement microscope (laser microscope), and the thickness was measured by laser microscope after the cross-sectional surface was polished.

Formation of a resin layer in the example will be described. The obtained alloying active material layer was washed with an acidic cleaner DP-320 (produced by Okuno Chemical Industries Co., Ltd.) at 30° C. for 60 seconds. After that, the alloying active material layer was immersed in sulfuric acid at room temperature for 30 seconds to wash the surface. Subsequently, polyimide resin was electrically deposited on the alloying active material layer at 30° C. and 100 V for 5 minutes. The electrically deposited polyimide resin was subjected to heat treatment at 180° C. for 45 minutes, thus forming the resin layer. The thickness of the resin layer was 10 μm when the thickness was measured by laser microscope.

A metal mask having a groove width of 1 μm and a thickness of 50 μm was used to cover the electrode, and then grooves were formed using excimer laser. After that, the mask portion was removed. Thus, the resin-coated tinned electrode was obtained.

Formation of a battery for evaluation in the example will be described. The resin-coated tinned electrode was cut in φ16 mm to obtain a negative electrode element. A φ19 mm lithium metal was used as the counter electrode. Two 20 μm separators made of polyethylene and an electrolytic solution of 1M LiPF₆ (in EC/DMC (1:1 vol. %)) were used. First, the φ19 mm counter electrode was put in a lower cover. A gasket is inserted from above the counter electrode to fix the counter electrode. After that, the two separators were put in. Subsequently, the negative electrode element was put in with the guide of the gasket so that the counter electrode in the lower cover faces the tinned surface. The 2 cc electrolytic solution was put therein, a spacer was placed, and then bubbles were purged. A waved washer was set, an upper cover was placed thereon, and then caulked by caulker. Thus, the battery for evaluation was obtained.

Evaluation in the example will be described. A test for inserting lithium at 0.645 mA and 25° C. to 0.01 V and then desorbing lithium to 1.5 V was repeated 30 times, and a capacity retention rate (=(capacity after 30 cycles)/(initial capacity)×100) was calculated from the initial capacity and the capacity after 30 cycles. The results were shown in Table 1.

Next, a comparative example will be described. In the comparative example, a battery for measurement was prepared in a manner similar to that of the example except that a copper foil having a rough surface was tinned and coated with resin and then the surface was etched so that the resin layer and the alloying active material layer are flush with each other. A test for inserting lithium at 0.598 mA and 25° C. to 0.01 V and then desorbing lithium to 1.5 V as well as the example was repeated 30 times, and a capacity retention rate was calculated. Then, the calculated capacity retention rate was evaluated. The results are shown in Table 1.

TABLE 1

| | | CAPACITY | |
|---|---|---|---|
| | INITIAL | AFTER 30 | RETENTION |
| | CAPACITY (mAh) | CYCLES (mAh) | RATE (%) |
| EXAMPLE | 2.43 | 1.98 | 81.5 |
| COMPARATIVE | 2.72 | 1.85 | 68.1 |
| EXAMPLE | | | |

As a result, the capacity retention rate is high in the example in which the surface of the negative electrode element has a step structure than the comparative example in which the surface of the negative electrode element has a flush structure.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

1. A negative electrode element for a lithium-ion secondary battery, comprising:
a negative electrode current collector; and
a negative electrode layer that is formed of an alloying active material layer and a resin layer, wherein the alloying active material layer is formed on the negative electrode current collector, wherein the resin layer is formed on a surface of the alloying active material layer so as to have an opening that exposes part of the alloying active material layer to a surface of the negative electrode layer, wherein
the surface of the alloying active material layer, exposed to the opening, and a surface of the resin layer form a step so that the surface of the resin layer is farther from a surface of the negative electrode current collector than the exposed surface of the alloying active material layer is.

2. The negative electrode element for a lithium-ion secondary battery according to claim 1, wherein a plurality of the openings are formed over the entire surface of the resin layer.

3. The negative electrode element for a lithium-ion secondary battery according to claim 1, wherein the resin layer covers an end portion of the alloying active material layer.

4. The negative electrode element for a lithium-ion secondary battery according to claim 1, wherein the size of the step falls within the range of 0.01 μm to 10 μm.

5. The negative electrode element for a lithium-ion secondary battery according to claim 4, wherein the size of the step falls within the range of 1 μm to 3 μm.

6. The negative electrode element for a lithium-ion secondary battery according to claim 1, wherein the entire surface of the alloying active material layer is covered with the resin layer.

7. The negative electrode element for a lithium-ion secondary battery according to claim 1, wherein the percentage of an area of the opening to an area of the entire resin layer falls within the range of 10% to 50%.

8. The negative electrode element for a lithium-ion secondary battery according to claim 7, wherein the percentage of an area of the opening to an area of the entire resin layer falls within the range of 30% to 40%.

9. A lithium-ion secondary battery comprising:
the negative electrode element for a lithium-ion secondary battery according to claim 1;
a positive electrode element for a lithium-ion secondary battery, wherein the positive electrode element includes a positive electrode current collector and a positive electrode layer;
a separator that is formed between the negative electrode layer and the positive electrode layer; and
a nonaqueous electrolytic solution that contains lithium salt.

10. A method of manufacturing a lithium-ion secondary battery, comprising:
forming an alloying active material layer on a negative electrode current collector; and
forming a resin layer on a surface of the alloying active material layer so as to have an opening that exposes part of the alloying active material layer to a surface of a negative electrode layer.

11. The method of manufacturing a lithium-ion secondary battery according to claim 10, wherein the alloying active material layer is formed after a surface of the negative electrode current collector is roughened.
